(19) United States
(12) Patent Application Publication
(10) Pub. No.: US 2026/0064848 A1
(43) Pub. Date: Mar. 5, 2026

(54) APPLICATION-LEVEL INTELLIGENT DETECTION ENGINEERING

(71) Applicant: SAP SE, Walldorf (DE)

(72) Inventor: Fatih Gey, Frankfurt am Main (DE)

(21) Appl. No.: 18/931,940

(22) Filed: Oct. 30, 2024

Related U.S. Application Data
(60) Provisional application No. 63/688,648, filed on Aug. 29, 2024.

(51) Int. Cl. G06F 21/57; G06F 21/64

(52) U.S. Cl. CPC G06F 21/572; G06F 21/577; G06F 21/64

(57) ABSTRACT

This disclosure describes systems, software, and computer implemented methods for a solution to make a threat signature part of the development process of a corresponding software feature and build the threat signature as a development artifact. That is, the specifics of a threat signature must be determined or defined, it must be implemented, tested, and deployed in a controlled and repeatable setting similar to the phases that the software feature itself is typically required to satisfy before deployment. Threat signatures can be development artifacts that reside alongside the source code, much like a configuration file. Any deployment or change of the software can trigger the deployment of its corresponding threat signature. In some implementations, this includes versioning. For example, software and deployed threat signature versions can be required to match, and updated threat signatures can be included in the update-rollouts.

### CLAIM OF PRIORITY

This application claims priority under 35 USC § 119 (e) to U.S. Patent Application Ser. No. 63/688,648, filed on Aug. 29, 2024, titled: “Application-Level Intelligent Detection Engineering”, the entire contents of which are hereby incorporated by reference.

### BACKGROUND

Computer systems increasingly use network resources and communicate via public communications networks (e.g., the internet). This has led to ever increasing digital attacks such as illicit access hacking, digital denial of service (DDoS) attacks, and others. Therefore, greater cyber security needs must be satisfied. The concept of cyber resilience, or the ability to anticipate and withstand cyber security incidents.

### SUMMARY

The present disclosure involves systems, software, and computer implemented methods for enhancing threat detection in a software environment, including identifying one or more indicators of a threat activity for threat monitoring for a software application in development. Receiving code for the software application in development. Analyzing the code to generate a threat signature based on the one or more indicators of threat activity, and generating a software development package including the code and the threat signature.

Implementations can optionally include one or more of the following features.

In some instances, the software development package can be deployed by deploying the code to a runtime environment for execution and deploying the threat signature to a security information and event management system (SIEM) executing in a runtime cluster that includes the runtime environment and monitors the network traffic of the runtime environment. I

In some instances, the threat signature includes a first version number, the code includes a second version number, and deploying the software development package includes confirming that the first and second version numbers match.

In some instances, generating the software deployment package includes compiling the code into a binary and including the binary in the software deployment package.

In some instances, the threat signature includes metadata indicating compatibility with one or more version of the code.

In some instances, updated code for the software application in development is received. One or more updated indicators of threat activity is identified, and an updated threat signature is generated based on the one or more updated indicators of threat activity. An updated software deployment package is generated that includes the updated code and the updated threat signature.

In some instances, the updated software deployment package includes metadata indicating a runtime environment to be updated.

In some instances, the software deployment package includes one or more software artifacts for deploying the code.

The details of these and other aspects and embodiments of the present disclosure are set forth in the accompanying drawings and the description below. Other features, objects, and advantages of the disclosure will be apparent from the description, drawings, and claims.

### DESCRIPTION OF DRAWINGS

Some example embodiments of the present disclosure are illustrated by way of example and not limitation in the figures of the accompanying drawings, in which like reference numbers indicate similar elements.

FIG. 1 is a schematic diagram illustrating an example system for generating and deploying application-level threat detection.

FIG. 2 is an example development and deployment timeline for generating and deploying application-level threat detection.

FIG. 3 is a flowchart illustrating an example process for generating and deploying application-level threat detection.

FIG. 4 is a block diagram illustrating an example of a computer-implemented system.

### DETAILED DESCRIPTION

This disclosure describes methods, software, and systems for generating and deploying application-level threat detection. Typically, threat detection is performed at the network level. Conventional threat-detection methods and tools mainly process network packets, owning very little information about the actual application activities on the protected systems, and falling back to interpolation to estimate what the activities are. As a result, conventional threat detection can perform well with high-quality output at network-level traffic (e.g., assessing that network protocols are used directly), but does not perform well (e.g., possibly having a high false-positives rate) when it comes to application-level insights.

Many businesses rely today on digital assets and systems, where those systems are complex, changing at high pace, and are built on numerous third-party assets. In consequence, ensuring their security properties to an absolute degree is often impossible or impracticable. Instead, security experts focus on the quality of cyber resilience, or that a breach must eventually be assumed. Hence, precautions to (i) detect such incidents early and (ii) recover from them quickly became necessary to limit the breach's damage to an organization. Potential damage can span the range from a breach with exfiltration of organizational intel but no data theft, up to an access and exfiltration of intellectual property or highly sensitive and PII data. Given this range, the associated costs in damage could span from negligible to fatal for the organization, respectively.

A high-quality (e.g., accurate) threat detection is imperative to cyber resilience, as it facilitates highly effective analysis-and-intervention operatives (e.g., due to low false-positive rates) on the one hand, and provides guiding, key indications for recovery and mitigation activities on the other.

Conventional practice, however, widely lacks high-quality threat-detection, offering either scalable approaches that stop at covering a base-line level of detective security, or in-depth (i.e. at application level) detective security in an ad-hoc fashion that does not scale. This disclosure addresses these shortcomings and presents a holistic approach to introduce rigor to a scalable development (as in software development) of threat detection artifacts, including tasks in the domain of modeling, testing, and automation infrastructure.

A software program, application, or software can be a cloud or on-premise deployed desktop or mobile application. It can log system or user activities, called log events, which are gathered and sent to a central security evaluation system for threat detection (SIEM). A SIEM can evaluate correlation rules and constraints on the log events, which can be defined as threat signatures. The SIEM can eventually raise an alert which issues a security-incident claim that immediately becomes an escalation activity, requesting for further investigation and remediation. A SIEM can raise alerts that are confirmed as no security incidents, rending the alert to be a false positive. Alerts that point to actual security alerts can be called true positives. The detection quality of a threat signature is the ratio of true to false positives. In other words, low false and high true positives mark a desirable quality. The act of developing a threat signature is called detection engineering, regardless of whether it is based on a rigid method or performed in an ad hoc fashion.

Application-level intelligence is an untapped domain for threat detection, although it carries valuable, distilled, and curated context on the activities in the software at hand and the acting user, providing highly contextualized input for precise threat detection. For out-of-band (or “odd”) states and behaviors inside the application, application-level intel is able to tell apart whether the business context (including the acting user in that up-to-date context) renders such actions as likely-to-be legitimate or malicious. Without that intel, such analysis is time consuming and error-prone, and often not feasible due to the lack of rigor of in-time captured forensic data.

In the current era of cyber security, at which network-focused threat detection is not being widely successful in pinning down modern breaches, visibility of application-level activities is the next level for threat detection to drastically improve performance.

The approaches for threat detection that do target the application-level model detection-engineering tasks (e.g., codifying application semantics into artifacts for the threat detection tools) do so as manual activities, where security-experienced personnel must reverse engineer (or guess) semantics of the log events reported by the application. This does not scale, and introduces the following shortcomings:

Problem 1, SM: Scalable means to deliver per-application-feature threat-signature descriptions: Preventive as well as detective security are significant qualities to software. Yet, in conventional practice, orders of magnitude more human resources are put in place to develop (secure) software artifacts (i.e. preventive security) than resources assigned to issue corresponding threat signatures (i.e. detective security).

A key reason for this inequal capacities is that the latter roles are scarce on the market.

Problem 2, SQ: Scalable quality to threat signatures: In conventional practice, developers design a feature (and therefore own all intimate details about its inner workings) while security experts distil threat signatures (which requires those very details) by either means of interviews or reverse engineering.

Either way, security experts attaining their understanding of the application by said means cannot gather the depth of understanding that developers have to holistically sketch how an application should or should not behave. Note that additional availability constraints and communication barriers between those two roles may additionally render the knowledge transfer incomplete.

As a result, in practice, only a subset of attention points are typically established that security experts explore, limiting a holistic security coverage. This directly corresponds to a significant drop of on detection quality.

Problem 3, CA: Coherency to application version: While for software components, there are rigid systems to ensure that component dependencies of a software are respected (e.g., the required components and their respective versions are deployed and operated together), there is no corresponding concept that ties threat signatures and corresponding application version into a deployment and operation unit.

These shortcomings result from the lack of a structured approach to develop threat signatures that put the developers' holistic understanding in the center.

This disclosure resolves these shortcomings by making a threat signature as part of the development process of a corresponding software feature, and building it as a development artifact. That is, the specifics of a threat signature can be determined or defined, implemented, tested, and deployed in a controlled and repeatable setting. This is similar to phases that the software feature itself typically has to be pass.

With this inclusion, the solution enables the following additional features:

1. Standalone maintenance of threat signature:

A threat signature can produce high noise, and hence be assessed to be of low quality. The act of improving such a threat signature can be performed by development; additional security expertise is not necessary, as the requirements for the threat signature does not change, but its implementation. Problems SM and SQ above benefit from this process.

2. Feature and threat signature co-related maintenance:

Whenever a software feature is changed, maintenance of the corresponding threat signature can be due as well. That is, requirements for the existing threat signature must be reassessed and changes applied; design, implementation, test, and deployment steps follow. Problems SM and SQ above benefit from this process.

3. Co-deployment of application and threat signature:

Threat signatures are to be development artifacts residing alongside the source code, much like a configuration file. Any deployment of the software shall trigger the deployment of its corresponding threat signature. Note that this includes versioning, i.e. software and deployed threat signature version must always match, and threat signature must be included in the update-rollouts. Problems SQ and CA benefit from this process.

In general, this disclosure describes a solution to make generating a threat signature part of the development process of a corresponding software feature and build the threat signature as a development artifact. That is, the specifics of a threat signature can be determined or defined, and the threat signature can be implemented, tested, and deployed in a controlled and repeatable setting similar to the phases that the software feature itself is typically required to satisfy before deployment. Threat signatures can be development artifacts that reside alongside, with, or are associated with the source code, much like a configuration file. Any deployment or change of the software can trigger the deployment of its corresponding threat signature. In some implementations, this includes versioning. For example, software and deployed threat signature versions can be required to match, and updated threat signatures can be included in updates or rollouts.

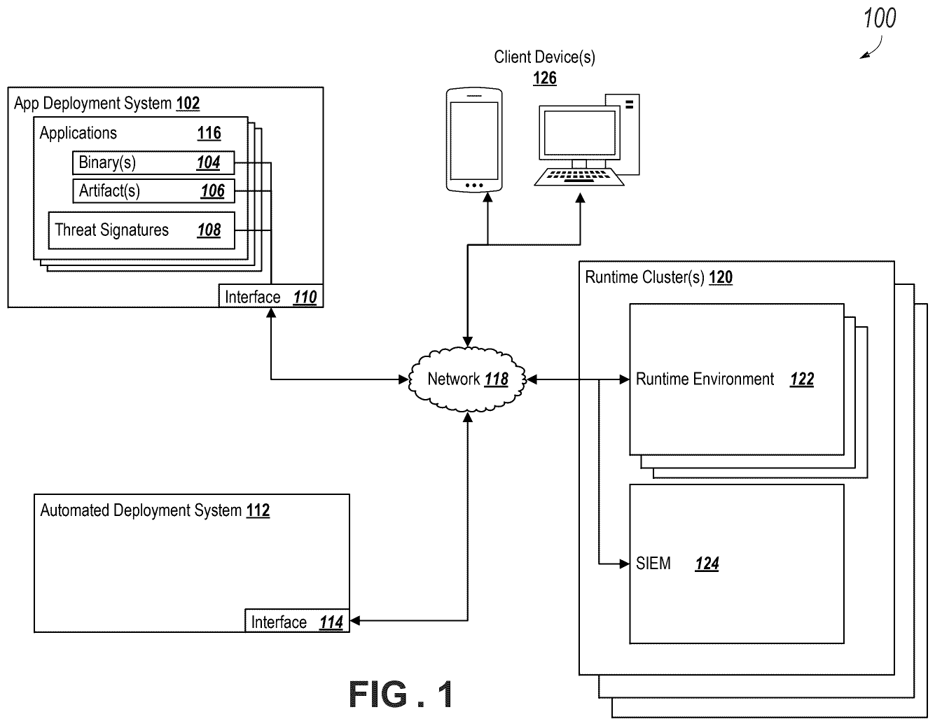

Turning to the illustrated example implementations, FIG. 1 illustrates an example system 100 for generating and deploying application-level threat detection. The system 100 includes an application deployment system 102, an automated deployment system 112, and one or more runtime clusters 120. These components, as well as one or more client devices 126 connect and communicate using a network 118.

Network 118 facilitates wireless or wireline communications between the components of the system 100 (e.g., between the application deployment system 102, the client device(s) 126, and the data marketplace runtime clusters 120), as well as with any other local or remote computers, such as additional mobile devices, clients, servers, or other devices communicably coupled to network 118, including those not illustrated in FIG. 1. In the illustrated environment, the network 118 is depicted as a single network, but can comprise more than one network without departing from the scope of this disclosure, so long as at least a portion of the network 118 can facilitate communications between senders and recipients. In some instances, one or more of the illustrated components can be included within or deployed to network 118 or a portion thereof as one or more cloud-based services or operations. The network 118 can be all or a portion of an enterprise or secured network, while in another instance, at least a portion of the network 118 can represent a connection to the Internet. In some instances, a portion of the network 118 can be a virtual private network (VPN). Further, all or a portion of the network 118 can comprise either a wireline or wireless link. Example wireless links can include 802.11a/b/g/n/ac, 802.20, WiMax, LTE, and/or any other appropriate wireless link. In other words, the network 118 encompasses any internal or external network, networks, sub-network, or combination thereof operable to facilitate communications between various computing components inside and outside the illustrated system 100. The network 118 can communicate, for example, Internet Protocol (IP) packets, Frame Relay frames, Asynchronous Transfer Mode (ATM) cells, voice, video, data, and other suitable information between network addresses. The network 118 can also include one or more local area networks (LANs), radio access networks (RANs), metropolitan area networks (MANs), wide area networks (WANs), all or a portion of the Internet, and/or any other communication system or systems at one or more locations.

Application deployment system 102 can be used for development, revision, and storage of updating applications. In general, the application deployment system 102 represents a repository for storing and versioning new or updated applications 116 to be deployed. Each application 116 in the application deployment system 102 includes binaries 104, artifacts 106, and threat signatures 108.

The binaries 104 are the executable code that will run in the runtime cluster 120 once deployed, allowing the software to run. In some implementations, the binaries 104 are compiled code that is specific to the particular runtime environment in which the binary 104 will execute (e.g., Windows, MacOS, Linux, etc.). In some implementations, instead of binaries 104, each application 116 includes source code, which is compiled or interpreted later during deployment.

Artifacts 106 can be additional files or objects required to execute the applications 116. Artifacts 106 can be, for example, configuration files, dependency lists, test cases, project planning documents, deployment packages, or resources (e.g., libraries or functions) that assist in the operation of the application 116. Additionally, artifacts 106 may include versioning information that indicates which version of the binaries 104 are available for deployment. In some implementations, the artifacts 106 are stored as tables structured file objects. For example, the artifacts 106 can be JSON objects.

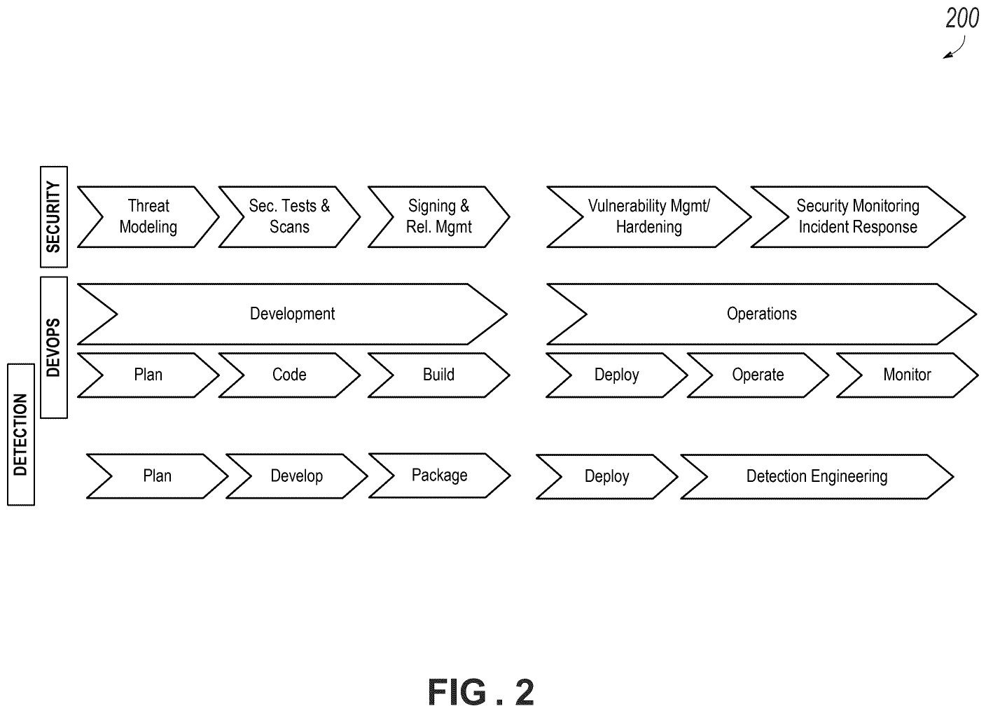

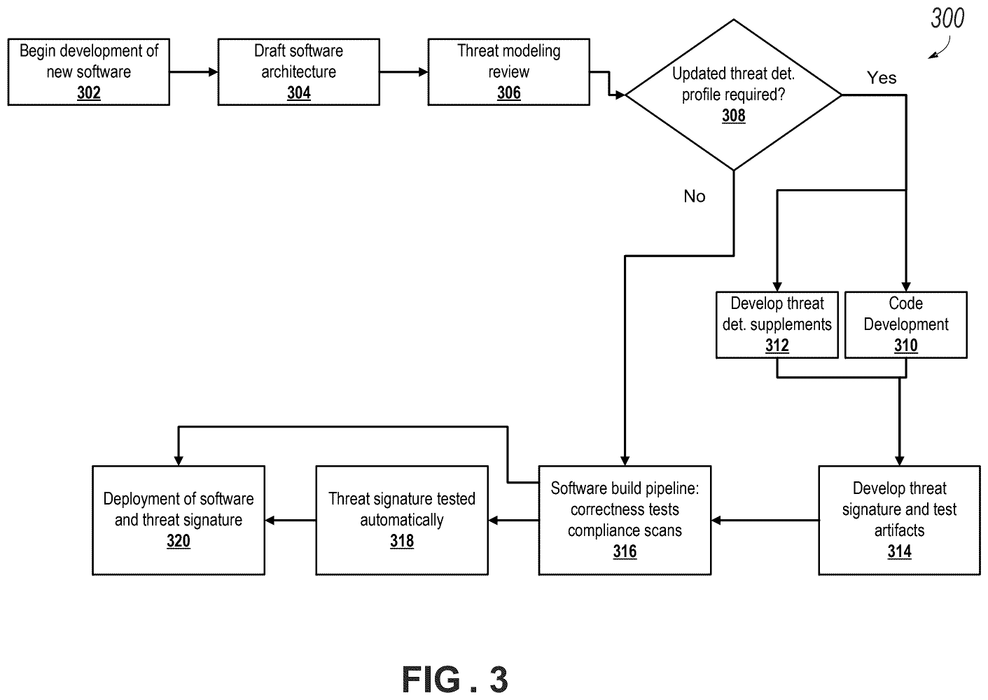

Threat signatures 108 are artifacts stored with each application 116 that indicate how expected threats or abuse of the application 116 may potentially manifest. The threat signatures 108 can provide detailed information on the expected appearance of illicit use or behavior of the application 116, and what unexpected behavior might indicate a threat. In some implementations, the threat signatures 108 include test cases or examples showing what threat behavior looks like. In some implementations, threat signatures 108 include specific operations and network traffic that are expected to appear if the scope of use for the application 116 is exceeded or subverted. The threat signatures 108 are generated during development of the application 116, as described in more detail below with reference to FIGS. 2 and 3, and are specialized artifacts that are consumed by a security information and event management system (SIEM) 124 to enhance cyber resilience. The threat signatures 108 can be stored as software objects such as JSON, XML, YAML, CSV, or other objects. For example, threat signatures 108 can be expressed in SIGMA, a scripting language, with the threat signatures 108 being stored as YAMLs.

Application 116 can constantly report about its behavior by producing log entries that are sent to the SIEM 124 system. In some implementations, the log entries are send using pull from sensors that push to SIEM 124, or a push from the application 116 to the SIEM 124. A threat signature 108 can describe a pattern for matching on log entries. A threat signature 108 can be “hit” (e.g., “cache hit”) by matching a single log entry. Alternatively, a “hit” can require matching multiple log entries. In some implementations, additional constraints may be carried by the threat signature 108, such as (i) a time windows in which two or more log entries need to be timestamped at, (ii) a connecting content attribute of the log entries (such as same user/actor or same processed entity at the application), (iii) an order in which the log entries (and therefore, the application behavior respectively) must to occur, or (iv) the presence of one log entry and the absence of another combined with constraints (i) to (iii) or other possibilities. In some implementations, a combination thereof is required to achieve a “hit”.

The application deployment system 102 communicates with the automated deployment system 112 and runtime clusters 120 via the network 118 using an interface 110. Interface 110 is used by the application deployment system 102 for communicating with other systems in a distributed environment-including within the system 100-connected to the network 118 (e.g., automated deployment system 112, and other systems communicably coupled to the illustrated application deployment system 102 and/or network 118). Generally, the interface 110 comprises logic encoded in software and/or hardware in a suitable combination and operable to communicate with the network 118 and other components. More specifically, the interface 110 can comprise software supporting one or more communication protocols associated with communications such that the network 118 and/or interface's 110 hardware is operable to communicate physical signals within and outside of the illustrated system 100. Still further, the interface 110 can allow the application deployment system 102 to communicate with the client 126, automated deployment system 112, and/or other portions illustrated within the system 100 to perform the operations described herein.

The automated deployment system 112 generally automates the process of updating and maintaining applications in the runtime clusters 120. The automated deployment system 112 can review the applications 116 in the application deployment system 102 and compare their respective versions to the deployed applications in the runtime environment 122. If a newer version exists, the automated deployment system 112 can extract a list of resources required from an artifact 106 (e.g., a manifest file), and fetches those resources and dependencies before deploying the application 116 to the runtime environment 122 then performing a cleanup of outdated, or unused resources within the runtime environment 122. The automated deployment system 112 includes an interface 114 that can be similar to, or different from interface 110, and is suitable for enabling communications between the various components of system 100.

When a new or updated application 116 is deployed, the automated deployment system 112 can further extract the corresponding threat signatures 108, which can be provided to the SIEM 124, for enhanced monitoring of activity associated with the newly deployed application in the runtime environment 122.

Runtime clusters 120 can be virtual machines (VM) or other cloud-based systems that generally provide services and resources to one or more client devices 126. Client devices 126 can access deployed applications and resources from the runtime environment 122 within the runtime cluster. Each runtime cluster can include multiple runtime environments 122 and a SIEM 124.

The SIEM 124 provides security event management services and security information management services. Generally, SIEM 124 consumes logs provided by various applications or sensors monitoring applications operating within the runtime cluster 120. The SIEM 124 can automatically analyze these logs and trigger security events to be followed up with either manually, or through an automated process. The SIEM 124 also enables analysts to browse through large amounts of data by providing filters, sorting capabilities, and other user interface features to either to detect a security issue, or to support forensics on a confirmed incident. Additionally, the SIEM 124 provides for management facilities such as incident filing, evidence collection, communication lines and records, and responsibilities.

The logged data can be used to correlate certain patterns and behaviors to enable quick or enhanced identification of unusual or suspicious activity. SIEM 124 can consume threat signatures 108 when new or updated applications 116 are deployed, and can use those threat signatures 108 on a per-application basis when analyzing logged events. This enables the SIEM 124 to more rapidly, and to accurately (e.g., fewer false positives) identify threat behavior, as well as when an application 116 is operating out of the ordinary.

FIG. 2 is an example development and deployment timeline for generating and deploying application-level threat detection. In modern software development, the methodology follows an iterative schema (e.g., “agile”) which focuses on delivering frequently with relatively small feature packages. This iterative schema weaves different aspects into a single development and deployment process. That is, development (Dev) and operation (Ops) activities form in DevOps a co-supporting and co-evolving process, allowing for improved operations and improved feedback from operations to development. Security built into software rather than addressing it as an afterthought results in three combined activities. The resulting DevSecOps method of developing software induces security activities along the entire process is illustrated in the top two rows of FIG. 2. This process enables building organically secure software.

The third row of FIG. 2 describes detection engineering or detective security. Conventionally detection engineering (a detective security means) is a single, monolithic activity that occurs in the operations phase of software deployment. The disclosed solution embeds detection engineering into the development phase, thereby enhancing overall system resilience. The detection activity consists of four main portions:

Plan: This activity is performed during a threat modeling workshop that gathers security and development teams together during early application development to explore detective security goals. Security experts, participation in this activity can deliver a list of ‘what to secure?’ while development teams involved are free in their decision space to formulate the ‘how.’

Develop: In this activity, development of the threat signature as well as prerequisites (such as having the software to produce additional log events) are performed by development teams during development of the software code itself.

Package: This activity encloses threat signatures into the application deployment unit. This activity will prepare the threat signature artifact to be bundled with the source code, adding technical meta information that is relevant for deployment. For example, the metadata can list versioning information of the threat signature, and a range of application versions to which it may be applicable.

Deploy: This activity ensures that the SIEM system receiving logs from a software will have the version-matching threat signature enrolled. The deploy activity consists of two parts. One is the deployment of the software. The other is deploying the threat signatures that belong to this application to a corresponding SIEM system. That is, in a potential landscape with many SIEM subsystems, the corresponding SIEM system to an application is the one that is connected to and receives logs from the application and processes them. In some implementations, there can be separate SIEM systems that are assigned exclusively to other applications.

The key effect of this activity is to ensure that a corresponding SIEM system-due to automatic co-deployment—has only those threat signatures enrolled to which the matching application versions are running and providing logs. Whenever the software will be updated, so is the threat signature. The application is deployed to the runtime environment and the threat signature to a SIEM. Both the runtime environment and the SIEM can operate in an environment that allows them to communicate securely to each other, for example, being placed both in the same infrastructure cluster node.

Once deployed, conventional detection engineering is enhanced because the SIEM performing the detection has access to the application-level threat signatures deployed with the application deployment unit. Because this process coexists with software development and can be version controlled within the same application deployment unit, when a software feature changes, the maintenance of a corresponding threat signature will proceed similar to the initial development, including the plan activity which can reassess whether security objectives must be adapted.

One example of the present solution can be described in context of an application for payroll. That application is typically used at the end of each quarter, however, the application is accessed by Alice from HR outside this typical time window. Alice may have one of the following three reasons for doing so: (i) A legitimate business reason, such as a new hire or out-of-cycle change of role or payment, (ii) Alice just noticed a mistake and fixed it, or (iii) she simply entered this application out of curiosity. All these options are, from a threat detection perspective, legitimate. In a fourth case, however, Alice's computer may have been utilized by a malicious actor (or script) to perform the access.

For purposes of description, assume that the fourth case has occurred, and that several systems have been compromised and back doors for malicious actors installed in preparation for the detected access to the HR system. If not taken care of immediately, these backdoors will be used to exfiltrate various types of data, including sensitive business data that is critical to the organization.

By applying the concept of application-level threat detection, any unusual access that the application (given the business context) can report as suspicious is powerful support to the endeavor of detecting threats timely and with high confidence (i.e., with a low chance for a false positive). By rendering needles in different haystacks visible, the solution allows analysts to form a pattern, and stop the adversary reaching his goals.

In a second example, an application for shipment and delivery is considered. There, the application queues n items before the queue is saturated (in some instances, this may be linked to the physical space in the warehouse or the amount of employees), and the queue is typically processed (e.g., the queue shrinks) before additional items are accepted. Adding items to a saturated queue may be justified in certain business cases (e.g., saturation capacity is actually raised), but not always.

This is yet another scenario where the application's awareness about a suspicious application state is invaluable. Note, that the parameters necessary to determine the point of saturation may be configurable (even only for the purpose of threat detection), deducted from other configuration parameters, or entirely derived from usage.

In a third example, a web-UI-based application may have several screens that are available at any time via a main-navigation pane: (i) book a transaction, (ii) view transactions by month, and (iii) admin/manage transactions. Each of those screens has additional sub-screens that a user accesses by either selecting an entity on the respective main screen, or by entering data and clicking next.

Although any subsequent screen is not directly accessible by means of a UI click-path, the subsequent screens could be accessed by entering the corresponding URL. Such behavior could imply an adversary saving time, unnecessary processing of application complexity (if scripted), or such behavior could map to an exploring-type reconnaissance activity.

While conventional means consider looking into attack vectors that exploit direct access to subsequent menus, potentially manipulating the session state, application-level threat detection focuses on excluding business motivation from a potential suspicious behavior. Legitimate cases for such access could be, for example, a result of using a browser bookmark, or a browser restarting a former session. In conjunction with the activities performed before or after the direct access, such access shortcuts can be mapped to an adversary strategy.

FIG. 3 is a flowchart illustrating an example process 300 for generating and deploying application-level threat detection. It will be understood that process 300 and related methods may be performed, for example, by any suitable system, environment, software, and hardware, or a combination of systems, environments, software, and hardware, as appropriate. For example, a system comprising a communications module, at least one memory storing instructions and other required data, and at least one hardware processor interoperably coupled to the at least one memory and the communications module can be used to execute process 300. In some implementations, the process 300 and related methods are executed by one or more components of the system 100 described above with respect to FIG. 1, such as the application deployment system 102, the automated deployment system 112, SIEM 124, and/or portions thereof.

At 302, development of new software is initiated. This can be development of an entirely new application, development of a new feature of an existing application, or a refinement of an existing feature/application.

At 304, the initial software architecture is drafted. This includes the design and flow of the software, as well as, at a high level, what the software will accomplish.

At 306, a threat modeling review is performed based on the drafted software architecture. In some implementations, a threat modeling workshop is performed to identify particular threats or threat patterns, as well as test cases and examples of expected threat behavior. This can include a two-prong step for threat modeling. A first prong can be a preventive security analysis, which will result in suggestions to change or add to current design to decrease the risk of a breach, or preventatively increase security. A second prong can be detective security, or how to readily detect (either during or afterwards) whether a breach has occurred. This second prong will result in “recipes” (i.e., threat signatures) to detect indicators of compromise. This includes test-cases (“recipes” to test threat signatures) for inputs and outputs.

At 308, based on the threat modeling review, a determination is made as to whether updated threat detection signatures are required. If updates are not needed, process 300 can skip operations 310-314, and can proceed immediately to 316. Otherwise, process 300 continues to 310. In some implementations, updates may not be necessary where a new software architecture/design fully recycles existing software and no new code/systems will be written.

At 310, the code is developed according to the software architecture. At this stage, the software code that will perform the intended task or tasks is generated. In some implementations, the code can be written by one or more software developers. In some implementations, the code is produced by a generative AI model in response to a prompt.

At 312, threat detection supplements are generated in parallel with code development (310). The threat detection supplements are supportive features in the application that can produce log events in response to behaviors that represent unexpected or suspicious activity. This adds functionality to the software for supporting additional awareness of threats, or pre-emptively providing information (for example, by means of logging) to certain activities.

At 314, when software and threat detection supplements are complete, threat signatures and test artifacts are developed. Test artifacts enable determination of whether the software is compliant with expected behavior. Concrete threat signatures and test cases for those threat signatures can be developed. In some implementations, supportive infrastructure (e.g., software tooling) is necessary to consume the threat artifacts. This software tooling can be specified in the threat artifacts or included within the software deployment package.

At 316, the software enters the build pipeline where certain correctness tests and compliance scans are performed. In modern software development, many checks are automated and multiple checks are run each time the source is changed. In some implementations, certain final checks are performed before release. This automated testing during the build pipeline provides early feedback while keeping quality standards high.

At 318, the threat signatures are tested similar to the software testing in the build pipeline. These can be automated checks and tests. In some implementations, the test cases generated at 312 and 314 are used. In some implementations, where new threat signatures were not required, 318 is bypassed.

At 320, the fully tested software and threat signature is deployed. The software is deployed simultaneously with or includes the deployment of threat signatures. As opposed to network-level detection, application deployments (versions, concrete configurations) may be different per landscape/cluster/staging area. By automating the deployment of threat signatures, quality of security monitoring rises, as version-aware threat signatures can be deployed and configured to process data from respective application versions/instances in the operation landscape. In some implementations, the threat signatures are deployed as an integrated part of the software. Each new version of software includes an updated version of its respective threat signature. This mitigates the risk that a threat goes unnoticed because application behavior between software versions changes.

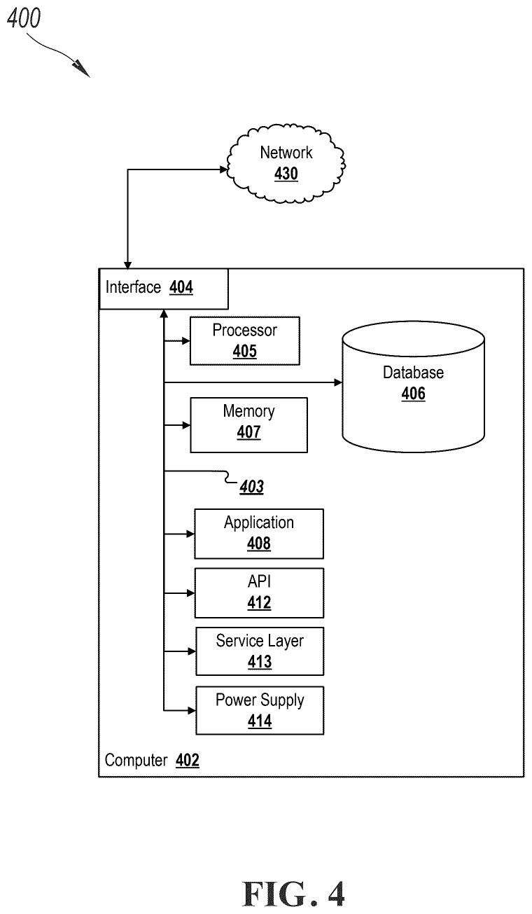

FIG. 4 is a block diagram illustrating an example of a computer-implemented system. 400 used to provide computational functionalities associated with described algorithms, methods, functions, processes, flows, and procedures, according to an implementation of the present disclosure. In the illustrated implementation, system 400 includes a computer 402 and a network 430.

The illustrated computer 402 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the computer 402 can include an input device, such as a keypad, keyboard, or touch screen, or a combination of input devices that can accept user information, and an output device that conveys information associated with the operation of the computer 402, including digital data, visual, audio, another type of information, or a combination of types of information, on a graphical-type user interface (UI) (or GUI) or other UI.

The computer 402 can serve in a role in a distributed computing system as, for example, a client, network component, a server, or a database or another persistency, or a combination of roles for performing the subject matter described in the present disclosure. The illustrated computer 402 is communicably coupled with a network 430. In some implementations, one or more components of the computer 402 can be configured to operate within an environment, or a combination of environments, including cloud-computing, local, or global.

At a high level, the computer 402 is an electronic computing device operable to receive, transmit, process, store, or manage data and information associated with the described subject matter. According to some implementations, the computer 402 can also include or be communicably coupled with a server, such as an application server, e-mail server, web server, caching server, or streaming data server, or a combination of servers.

The computer 402 can receive requests over network 430 (for example, from a client software application executing on another computer 402) and respond to the received requests by processing the received requests using a software application or a combination of software applications. In addition, requests can also be sent to the computer 402 from internal users (for example, from a command console or by another internal access method), external or third-parties, or other entities, individuals, systems, or computers.

Each of the components of the computer 402 can communicate using a system bus 403. In some implementations, any or all of the components of the computer 402, including hardware, software, or a combination of hardware and software, can interface over the system bus 403 using an application programming interface (API) 412, a service layer 413, or a combination of the API 412 and service layer 413. The API 412 can include specifications for routines, data structures, and object classes. The API 412 can be either computer-language independent or dependent and refer to a complete interface, a single function, or even a set of APIs. The service layer 413 provides software services to the computer 402 or other components (whether illustrated or not) that are communicably coupled to the computer 402. The functionality of the computer 402 can be accessible for all service consumers using the service layer 413. Software services, such as those provided by the service layer 413, provide reusable, defined functionalities through a defined interface. For example, the interface can be software written in a computing language (for example, JAVA or C++) or a combination of computing languages, and providing data in a particular format (for example, extensible markup language (XML)) or a combination of formats. While illustrated as an integrated component of the computer 402, alternative implementations can illustrate the API 412 or the service layer 413 as stand-alone components in relation to other components of the computer 402 or other components (whether illustrated or not) that are communicably coupled to the computer 402. Moreover, any or all parts of the API 412 or the service layer 413 can be implemented as a child or a sub-module of another software module, enterprise application, or hardware module without departing from the scope of the present disclosure.

The computer 402 includes an interface 404. Although illustrated as a single interface 404, two or more interfaces 404 can be used according to particular needs, desires, or particular implementations of the computer 402. The interface 404 is used by the computer 402 for communicating with another computing system (whether illustrated or not) that is communicatively linked to the network 430 in a distributed environment. Generally, the interface 404 is operable to communicate with the network 430 and includes logic encoded in software, hardware, or a combination of software and hardware. More specifically, the interface 404 can include software supporting one or more communication protocols associated with communications such that the network 430 or hardware of interface 404 is operable to communicate physical signals within and outside of the illustrated computer 402.

The computer 402 includes a processor 405. Although illustrated as a single processor 405, two or more processors 405 can be used according to particular needs, desires, or particular implementations of the computer 402. Generally, the processor 405 executes instructions and manipulates data to perform the operations of the computer 402 and any algorithms, methods, functions, processes, flows, and procedures as described in the present disclosure.

The computer 402 also includes a database 406 that can hold data for the computer 402, another component communicatively linked to the network 430 (whether illustrated or not), or a combination of the computer 402 and another component. For example, database 406 can be an in-memory or conventional database storing data consistent with the present disclosure. In some implementations, database 406 can be a combination of two or more different database types (for example, a hybrid in-memory and conventional database) according to particular needs, desires, or particular implementations of the computer 402 and the described functionality. Although illustrated as a single database 406, two or more databases of similar or differing types can be used according to particular needs, desires, or particular implementations of the computer 402 and the described functionality. While database 406 is illustrated as an integral component of the computer 402, in alternative implementations, database 406 can be external to the computer 402. The database 406 can hold any data type necessary for the described solution.

The computer 402 also includes a memory 407 that can hold data for the computer 402, another component or components communicatively linked to the network 430 (whether illustrated or not), or a combination of the computer 402 and another component. Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407, two or more memories 407 or similar or differing types can be used according to particular needs, desires, or particular implementations of the computer 402 and the described functionality. While memory 407 is illustrated as an integral component of the computer 402, in alternative implementations, memory 407 can be external to the computer 402.

The application 408 is an algorithmic software engine providing functionality according to particular needs, desires, or particular implementations of the computer 402, particularly with respect to functionality described in the present disclosure. For example, application 408 can serve as one or more components, modules, or applications. Further, although illustrated as a single application 408, the application 408 can be implemented as multiple applications 408 on the computer 402. In addition, although illustrated as integral to the computer 402, in alternative implementations, the application 408 can be external to the computer 402.

The computer 402 can also include a power supply 414. The power supply 414 can include a rechargeable or non-rechargeable battery that can be configured to be either user- or non-user-replaceable. In some implementations, the power supply 414 can include power-conversion or management circuits (including recharging, standby, or another power management functionality). In some implementations, the power supply 414 can include a power plug to allow the computer 402 to be plugged into a wall socket or another power source to, for example, power the computer 402 or recharge a rechargeable battery.

There can be any number of computers 402 associated with, or external to, a computer system containing computer 402, each computer 402 communicating over network 430. Further, the term “client,” “user,” or other appropriate terminology can be used interchangeably, as appropriate, without departing from the scope of the present disclosure. Moreover, the present disclosure contemplates that many users can use one computer 402, or that one user can use multiple computers 402.

This detailed description is merely intended to teach a person of skill in the art further details for practicing certain aspects of the present teachings and is not intended to limit the scope of the claims. Therefore, combinations of features disclosed above in the detailed description may not be necessary to practice the teachings in the broadest sense and are instead taught merely to describe particularly representative examples of the present teachings.

Unless specifically stated otherwise, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A computer implemented method for enhancing threat detection in a software environment comprising:
identifying, for a software application in development, one or more indicators of threat activity for threat monitoring;
receiving code for the software application in development;
analyzing the code to generate a threat signature based on the one or more indicators of threat activity; and
generating a software deployment package comprising the code and the threat signature.

2. The method of claim 1, comprising:
deploying the software deployment package by:
deploying the code to a runtime environment for execution; and
deploying the threat signature to a security information and event management system (SIEM) executing in a runtime cluster comprising the runtime environment and monitoring network traffic of the runtime environment.

3. The method of claim 2, wherein the threat signature comprises a first version number, the code comprises a second version number, and wherein deploying the software deployment package comprises confirming that the first version number matches the second version number.

4. The method of claim 1, wherein generating the software deployment package comprises: compiling the code into a binary and including the binary in the software deployment package.

5. The method of claim 1, wherein the threat signature comprises metadata indicating compatibility with one or more versions of the code.

6. The method of claim 1 comprising:
receiving updated code for the software application in development;
identifying one or more updated indicators of threat activity;
generating an updated threat signature based on the one or more updated indicators of threat activity; and
generating an updated software deployment package comprising the updated code, and the updated threat signature.

7. The method of claim 6, wherein the updated software deployment package comprises metadata indicating a runtime environment to be updated.

8. The method of claim 1, wherein the software deployment package comprises one or more software artifacts for deploying the code.

9. A non-transitory, computer-readable medium storing one or more instructions executable by a computer system to perform operations comprising:
identifying, for a software application in development, one or more indicators of threat activity for threat monitoring;
receiving code for the software application in development;
analyzing the code to generate a threat signature based on the one or more indicators of threat activity; and
generating a software deployment package comprising the code and the threat signature.

10. The medium of claim 9, comprising:
deploying the software deployment package by:
deploying the code to a runtime environment for execution; and
deploying the threat signature to a security information and event management system (SIEM) executing in a runtime cluster comprising the runtime environment and monitoring network traffic of the runtime environment.

11. The medium of claim 10, wherein the threat signature comprises a first version number, the code comprises a second version number, and wherein deploying the software deployment package comprises confirming that the first version number matches the second version number.

12. The medium of claim 9, wherein generating the software deployment package comprises: compiling the code into a binary and including the binary in the software deployment package.

13. The medium of claim 9, wherein the threat signature comprises metadata indicating compatibility with one or more versions of the code.

14. The medium of claim 9 comprising:
receiving updated code for the software application in development;
identifying one or more updated indicators of threat activity;
generating an updated threat signature based on the one or more updated indicators of threat activity; and
generating an updated software deployment package comprising the updated code, and the updated threat signature.

15. The medium of claim 14, wherein the updated software deployment package comprises metadata indicating a runtime environment to be updated.

16. The medium of claim 9, wherein the software deployment package comprises one or more software artifacts for deploying the code.

17. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
identifying, for a software application in development, one or more indicators of threat activity for threat monitoring;
receiving code for the software application in development;
analyzing the code to generate a threat signature based on the one or more indicators of threat activity; and
generating a software deployment package comprising the code and the threat signature.

18. The system of claim 17, comprising:
deploying the software deployment package by:
deploying the code to a runtime environment for execution; and
deploying the threat signature to a security information and event management system (SIEM) executing in a runtime cluster comprising the runtime environment and monitoring network traffic of the runtime environment.

19. The system of claim 18, wherein the threat signature comprises a first version number, the code comprises a second version number, and wherein deploying the software deployment package comprises confirming that the first version number matches the second version number.

20. The system of claim 17, wherein generating the software deployment package comprises: compiling the code into a binary and including the binary in the software deployment package.
